(19) United States
(12) Patent Application Publication
(10) Pub. No.: US 2005/0166983 A1
(43) Pub. Date: Aug. 4, 2005

(54) Flush mounted waste disposal service panel assembly

(76) Inventors: James R. Shaw, Naples, FL (US); Philip E. Jones, Naples, FL (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/772,043

(22) Filed: Feb. 3, 2004

(51) Int. Cl. G05D 7/00

(52) U.S. Cl. 137/899.2

(57) ABSTRACT

The waste disposal service panel assembly includes a housing, waste drain valve, rinse/fill valve, handle assembly and service panel door. The housing has a tubular side wall and a base near one end of the side wall. The waste drain valve is at least partially mounted within the housing through the base. The waste drain valve includes an outlet positioned within the housing and an inlet configured to couple to a waste collection tank within a aircraft. The service panel door is pivotally coupled to the housing near an end of the side wall remote from the base. The service panel door has an outer surface configured to substantially match an outer contour of the aircraft's skin, and an outer cap coupled to an inner surface of the service panel door. The outer cap is configured and dimensioned to mate with the outlet to seal the outlet when the service panel door is closed.

### BACKGROUND OF THE INVENTION

1. Field of the Invention

This invention pertains to liquid valve seals, particularly those used for sealing aircraft lavatory waste drain valves. This invention further relates to a waste disposal service panel assembly including a waste disposal service panel assembly housing and flush-mounted cover for positively sealing an aircraft waste drain valve to prevent waste fluid leakage. In a preferred embodiment, the cover of the waste disposal service panel assembly matches the contour of the aircraft and is dimensioned such that it cannot close if other associated components within the housing have not been properly closed.

2. Description of Related Art

Commercial passenger airliners and other commercial aircraft have lavatories whose waste is collected during flight in one or more holding tanks on board the aircraft. Typically, holding tanks are emptied after landing via a waste disposal service panel assembly on the exterior of the aircraft. The waste disposal service panel assembly generally contains a waste drain valve for emptying the waste collection tank. When the tank is to be emptied, the service panel door is opened and then after opening the waste drain valve outer cap, a waste drain hose of an airport waste disposal facility is coupled to the waste drain valve and a waste drain valve inner door is opened. The waste may then be allowed to flow out of the tank under the force of gravity alone, or suction may be used to draw the waste from the tank.

The waste drain valve is typically located beneath a service panel door. The service panel door generally includes a hinge and locking mechanism to provide access to the waste disposal service panel and waste drain valve. Other components required for operation of the waste drain valve are typically also located underneath the service panel door, including a rinse fill valve and handle assembly for flushing and replenishing the collecting tanks after they have been drained.

A typical structure for a waste drain valve is disclosed in U.S. Pat. No. 4,098,427 (“the '427 patent”) to Duckworth, which is incorporated herein by reference. The '427 patent shows a double sealing, two-door valve, with a first door 12 and a second door 18 enclosing the first door. The primary purpose of the double sealing two door valve is to reduce leakage. However, the multiplicity of valve doors adds additional weight and cost to the aircraft. Increased weight also increases fuel costs. Furthermore, because both of these valve doors are located beneath the service panel door, the valve doors can be unintentionally left open and hidden from view after closure of the service panel door. This in turn, leads to leakage and associated safety concerns.

A particular concern of current waste disposal service panel assemblies is that they do not provide an adequate seal to prevent leakage of fluids originating from the waste drain valve, rinse/fill valve, handle assembly, or other mounting interfaces. In addition, any liquid leaking through the aforementioned interfaces can then seep through the outer service panel door and, because of extremely cold temperatures experienced at high altitudes, will freeze. The frozen material can break off in flight, and constitutes a hazard to the aircraft and those on the ground below.

Another problem with the frozen material is that it may freeze the waste drain valve inner door closed so that it cannot be opened when the waste holding tank is to be emptied after landing. An additional problem with the mounting interface consists of the installation of multiple flanges, gaskets, rivets, fittings, or the like that are normally designed to eliminate leak paths. However, each mounting may cause a leak path if improperly installed or damaged during service. Installation of these multiple components consumes significant assembly time. Additional assembly time is also required to perform pressure testing after installation, as well as testing during general maintenance of aircraft, to ensure adequate sealing.

Accordingly, a waste disposal service panel assembly that addresses the drawbacks of the prior art would be highly desirable. In particular, it would be advantageous to provide a waste disposal service panel assembly that is less prone to leakage, is simpler and less costly to operate and install, and is of lower weight than current waste disposal service panel assembly assemblies.

### SUMMARY OF THE INVENTION

According to the present invention, there is provided a waste disposal service panel assembly. The waste disposal service panel assembly includes a housing, a waste drain valve, and a service panel door. The housing has a tubular side wall and a base near one end of the side wall. The waste drain valve is at least partially mounted within the housing through the base. The waste drain valve includes an outlet configured to form a coupling for mating to a typical waste drain hose used at an airport facility within the housing and an inlet configured to couple to a waste collection tank located on board the aircraft. The service panel door is pivotally coupled to the housing near an end of the side wall remote from the base. The service panel door has an outer surface configured to substantially match an outer contour of the aircraft's skin, and an outer cap incorporated into the inner surface of the service panel door. The outer cap is configured and dimensioned to mate with and seal the outlet of the waste drain valve and force the inner door closed, sealed and locked when the service panel door is closed and/or closed and locked

Additional waste drain valve components include an inner valve door coupled within the outlet and which can be operated after the waste drain hose is coupled to the waste drain valve outlet. This prevents onboard waste fluid from discharging onto the tarmac in the interim between the operator opening the service panel door and coupling the waste drain hose to the waste drain valve outlet. The inner door also allows clean access to other components inside the housing. Other components incorporated into the housing preferably include a rinse/fill valve, handle assembly, or the like. In addition, the waste disposal service panel assembly is configured and dimensioned such that the service panel door cannot close and lock if other associated service panel components within the housing, such as the rinse/fill valve, or handle assembly, are not closed and locked.

This invention may be used on any craft requiring a need for liquid waste disposal, and more specifically in the field of aircraft lavatory waste drain valves. This invention is advantageous over the prior art because it is less prone to leakage, is simpler and less costly to operate and install, and is of lower weight than current waste drain valve assemblies. In particular, many of the components of the waste disposal service panel assembly are preferably manufactured in a single unit such that the dimensions between the service panel door and the waste drain valve can be carefully controlled. This dimensional control and lack of interfaces between components reduces leak paths by avoiding the necessity for additional seals or gaskets between neighboring components. It also ensures a good fit, and, accordingly, a good seal between the service panel door and the outlet of the waste drain valve.

Finally, incorporating the waste drain valve outer cap into the waste disposal service panel assembly door removes the need for two separate components, i.e., a outer panel door and an outer waste drain valve door, and all associated hardware, such as hinges, locking mechanisms, fasteners, or the like. It also simplifies installation and assembly of the entire waste disposal service panel assembly and is beneficial in the reduction or elimination of possible leak paths while simplifying manufacturability and reducing weight which results in cost savings associated with manufacturing, installation, maintenance, and fuel costs.

### BRIEF DESCRIPTION OF THE DRAWINGS

For a better understanding of the nature and objects of the invention, reference should be made to the following detailed description, taken in conjunction with the accompanying drawings, in which:

FIG. 1 is a side view of a waste disposal service panel assembly, according to an embodiment of the present invention;

FIG. 2 is an isometric view of the waste disposal service panel assembly of FIG. 1 with the cover in an open position; and

FIG. 3 is a sectional view taken on line 3-3 in FIG. 2 of the waste disposal service panel assembly shown in FIG. 1;

FIG. 4 is a top view of the waste disposal service panel assembly shown in FIG. 1, with the cover in a closed position.

Like reference numerals refer to corresponding parts throughout the several views of the drawings.

### DETAILED DESCRIPTION OF THE INVENTION

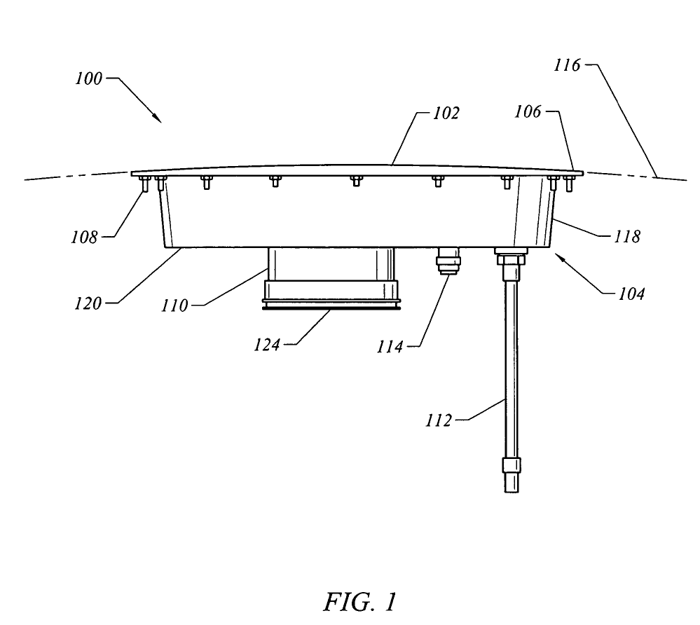

FIG. 1 is a side view of a waste disposal service panel assembly 100. The waste disposal service panel assembly includes a service panel door 102 and a waste disposal service panel assembly housing 104. The outer portion of the service panel door 102 preferably conforms to the contour of the aircraft's skin 116 at a desired aircraft fuselage location. The waste disposal service panel assembly housing 104 is recessed into the aircraft fuselage beneath the aircraft skin 116. The housing preferably has tubular side walls 118 and a base 120 substantially sealing the housing at one end. A flange 106 with a diameter larger than the diameter of the service panel door 102 is preferably provided at the outer perimeter of the housing 104. The flange 106 provides a surface for attaching the housing 104 to the aircraft fuselage or aircraft skin 116. During aircraft manufacture, the flange 106 is preferably riveted or bolted 108 to the aircraft skin 116.

Interior to the housing 104, located within the base 120, is a waste drain valve 110 which fluidly communicates with one or more waste collection tanks within the aircraft (not shown). Also interior to the housing 104 is preferably a handle assembly 112 for activating flow to the waste drain valve. A rinse/fill valve 114 is also preferably located within the housing 104. The rinse/fill valve 114 is also preferably connected to the waste collection tank (not shown). The waste drain valve, handle assembly, and rinse/fill valve preferably at least partially penetrate the base 120. It should be appreciated that other associated components may also be accommodated in the waste disposal service panel assembly 100 by providing an appropriate sized opening within the base 120 of the housing 104.

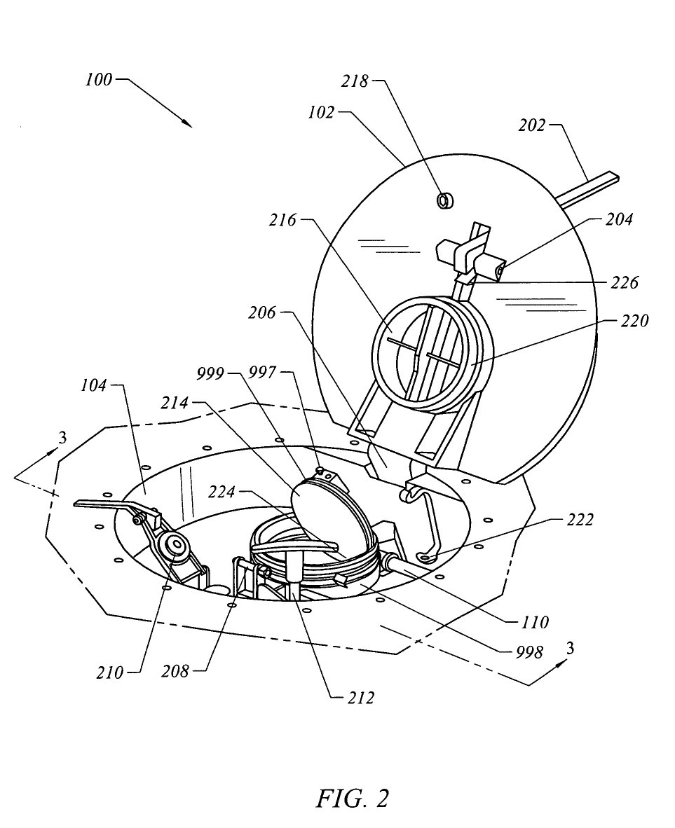

The waste drain valve 110 generally has a tubular side wall, one end of which forms a outlet 224 (FIG. 2) located within the housing 104 and the opposite end of which forms an inlet 124. The inlet 124 is attached to the collecting tank within the aircraft. The outlet 224 (FIG. 2) is preferably configured to form a coupling for mating to a typical waste drain hose used at an airport facility.

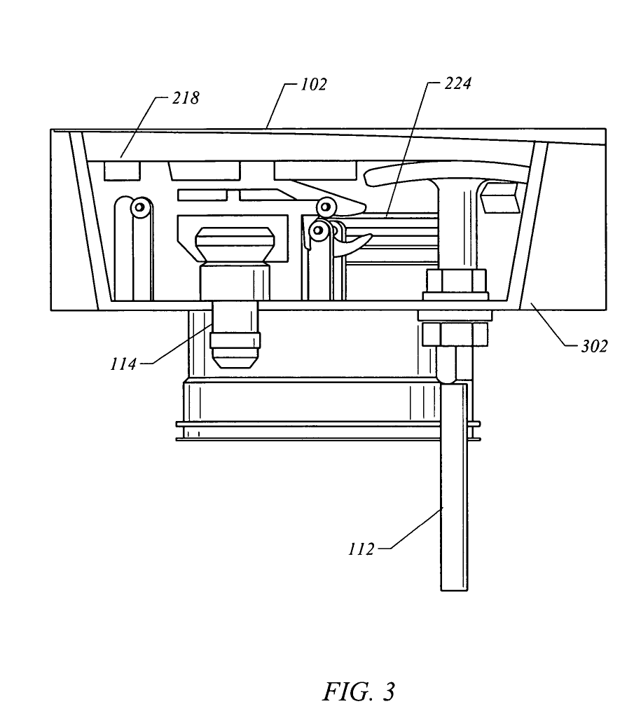

FIG. 2 is an isometric view of the waste disposal service panel assembly 100 with the service panel door 102 in an open position. The service panel door 102 is pivotable about a hinge 206 between an open and a closed position. The service panel door 102 has a handle 202, pivotally coupled to the service panel door 102 via a pivot 204. The hinge 206 is located near the flange of the housing 104 and attaches the service panel door 102 to the housing 104. The handle 202 also has a clasp 226 that interacts with a locking mechanism 208 near the outlet 224 when the handle 202 is closed and locked flush with the outer surface of the service panel door 102. The locking mechanism securely locks the service panel door 102 closed after the waste drain valve 110, rinse/fill valve 114 and handle assembly 112, or the like have been closed and locked. (See FIG. 3).

If either the cap 210 of the rinse/fill valve 114 (FIG. 1) or the handle 212 of the handle assembly 112 (FIG. 1) have not been properly closed and locked, they do not allow the service panel door 102 to be closed and locked, i.e., they interfere with the service panel door. For example, FIG. 2 shows the cap 210 of the rinse/fill valve 114 in an open position, which would interfere with closure of the service panel door 102, also if the rinse/fill valve 114 cap 210 was not completely closed and locked, it would still interfere with a raised boss 218 incorporated into the underside of the service panel door 102. In another embodiment, the handle 212 of the handle assembly 112 can also interfere with the underside of the service panel/outer cap if the handle is not in the fully closed (down) position. This interference provides a safety function because the service panel door 102 cannot be closed and locked when the waste drain valve 110 and/or other associated components within the housing 104 have not been properly closed and locked. As such, a service panel door 102 that cannot be fully closed is a warning that leakage may occur, as the internal components are not fully closed and locked.

The waste drain valve 110 also includes an inner door 214, with O-ring 999, hinged within the outlet 224. An inner door handle 222 is used to open and close the inner door 214. The inner door 214 is also preferably spring loaded, such that when the safety lock latch handle 998 is “pushed to open” it rotates the positive lift latch shaft against the lift pin 997 on the inner door 214 and forces it up and out of the sealed configuration allowing the inner door 214 to be opened by a spring force. In use, once a waste drain hose of an airport waste disposal facility is coupled to the waste drain valve 110, the waste drain valve's inner door 214 is opened so that waste may be extracted.

An outer cap 216 is preferably incorporated into the underside of the service panel door 102 and positioned to mate with the outlet 224 of the waste drain valve 110 when the service panel door 102 is closed and locked. In a preferred embodiment, the outer cap 216 includes an O-ring 220 that seals the outlet 224 of the waste drain valve 110 to prevent leakage. When closed, the outer cap 216 forces the inner door 214 to close, seal, and lock the outlet 224. The inner door 214 is locked into place until released by the safety lock latch handle 998. The inner door handle 222 is used as an indicator flag providing visual proof that the inner door 214 is either fully opened or closed, sealed, and locked. It can also be used to manually open the inner door 214 in situations where waste material or any foreign matter may prevent the inner door 214 from opening from spring force alone. The handle 222 can also be used to manually close the inner door 214, if desired, before the waste drain hose of an airport waste disposal facility is uncoupled from the waste drain valve outlet.

In an alternative embodiment, the outer cap 216 is coupled to the service panel door 102 and not incorporated into it. In other words, the outer cap 216 may be incorporated into the service panel door 102 by any suitable means, such as by being cast together with the service panel door, or it may be coupled to the service panel door, such as by being welded or bolted to the service panel door. The outer cap 216 must, however, close together with the service panel door.

FIG. 3 is a better view of the waste disposal service panel assembly 100 with the service panel door closed. The waste drain valve 110 (FIG. 1) is sealed by proper closure of the service panel door 102 (FIG. 1) against the waste drain valve 110 (FIG. 1) in combination with the compression of the O-ring 220 (FIG. 2) on the inner bore of the outlet 224 (FIG. 2) and the locking of the handle 202 (FIG. 2). Furthermore, incorporation of the outer cap 216 into the service panel door 102 removes the need for a separate outer valve door over the waste drain valve 110 and a separate service panel door. The overall weight, complexity, and cost of the waste disposal service panel assembly 100 is, therefore, reduced, and associated aircraft fuel costs are correspondingly lowered.

In a preferred embodiment, many of the components of the waste disposal service panel assembly 100 are preferably manufactured in a single unit such that the dimensions between the service panel door 102 and the waste drain valve 110 can be carefully controlled. This dimensional control and lack of interfaces between components reduces leak paths by avoiding the necessity for additional seals or gaskets and associated hardware between neighboring components. It also ensures a good fit between the outer cap 216 of the service panel door 102 and the outlet 224 of the waste drain valve 110. Similarly, in a preferred embodiment, the service panel door 102 cannot be closed and locked if other associated components such as the rinse/fill valve 114 or handle assembly 112 are not properly closed and locked.

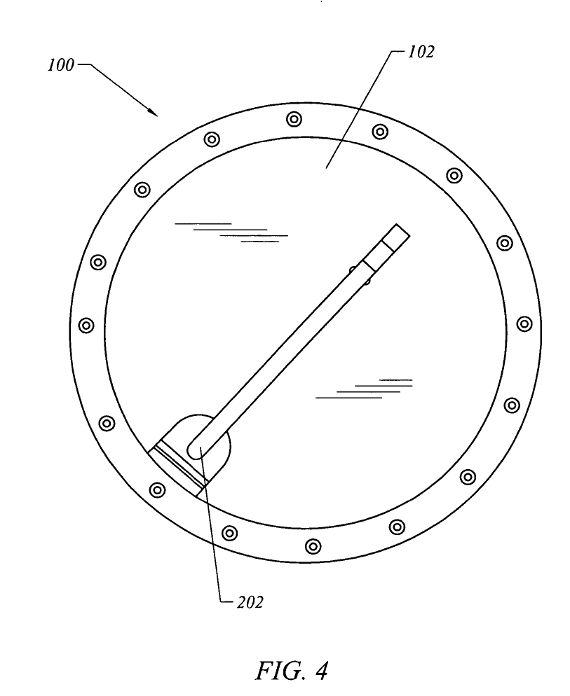

FIG. 4 is a top view of the waste disposal service panel assembly 100 shown in FIG. 1 with the service panel door 102 in a closed position. When properly stowed and locked, the distal portion of the handle 202 is preferably positioned in a 7 to 8 o'clock position with respect to the aft portion of the aircraft being at 9 o'clock. Conversely, when the handle is open, the service panel door 102 opens under its own weight and the handle and door hangs down at the 7 to 8 o'clock position with respect to the aft portion of the aircraft being at 9 o'clock. This allows access to the waste drain valve 110 and other associated component such as the rinse/fill valve 114 or handle assembly 112.

The position of the handle 202 and hinge 206 have two advantages. First, the handle and service panel door are less likely to open accidentally when being stuck by debris passing the aircraft in flight. Second, the likelihood of the service panel door being accidentally left open is minimized, for if left open the door will tend to hang open completely under its own weight.

In addition, all components of the waste disposal service panel assembly 100 are preferably made of materials that are resistant to corrosion from lavatory waste, and have appropriate mechanical and dimensional stability at low temperatures.

Accordingly, the waste disposal service panel assembly 100 is less prone to leakage, is simpler and less costly to operate and install, and is of lower weight than current waste disposal service panel assemblies. In particular, the outer cap 216 located on the interior portion of the service panel door 102, is positioned to seal the outlet 224 of the waste drain valve 110 when the service panel door 102 is closed and locked to prevent leakage. This completely eliminates the need for a separate outer door for the waste drain valve. The waste disposal service panel assembly 100 also has a safety feature that it will not close if the waste drain valve 110 or other associated components such as the rinse/fill valve 114 or handle assembly 112 are not properly closed and locked.

The foregoing description of a specific embodiment of the present invention are presented for purposes of illustration and description. This is not intended to be exhaustive or to limit the invention to the precise forms disclosed. Obviously many modifications and variations are possible in view of the above teachings. For example, a small raised boss 218 may be located on the underside of the service panel door 102, which provides minimal clearance between the rinse/fill valve 114, or other associated components located within the housing 104. These modifications insure that the components of the waste disposal service panel assembly 100 are not left in the open or unlocked position, thereby reducing the possibility of potential leakage. Furthermore, additional doors or caps may be incorporated into the service panel door, such as the rinse/fill valve door, or the like. Other embodiments may be advantageous for reasons of cost, fuel efficiency, safety, or the like. The embodiments were chosen and described above in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

1. A waste disposal service panel assembly comprising:
a housing;
a waste drain valve coupled to said housing, said waste drain valve comprising:
an outlet within said housing, where said outlet is configured to removably couple to a waste drain hose for drainage of a waste collection tank; and
an inlet configured to couple to said waste collection tank; and
a service panel door pivotally coupled to said housing, said service panel door comprising:
an outer surface configured to substantially match an outer contour of an aircraft's skin; and
an inner surface having an outer cap configured and dimensioned to mate with said outlet to seal said outlet when said service panel door is in a closed position.

2. The waste disposal service panel assembly of claim 1, wherein said housing comprises a substantially tubular side wall and a base near one end of said side wall.

3. The waste disposal service panel assembly of claim 2, wherein said housing further includes a rinse/fill valve and handle assembly coupled to said housing at least partially within said base.

4. The waste disposal service panel assembly of claim 1, wherein said housing further includes waste drain valve components within said housing selected from a group consisting of: handles, levers, hinges, locking mechanisms, springs, clasps, and fasteners.

5. The waste disposal service panel assembly of claim 4, wherein said housing is configured and dimensioned such that said service panel door cannot close and lock if at least one of said waste drain valve components is not closed an locked.

6. The waste disposal service panel assembly of claim 1, wherein said housing further includes a rinse/fill valve and handle assembly coupled to said housing.

7. The waste disposal service panel assembly of claim 1, wherein said waste drain valve further comprises an inner door pivotally mounted within said outlet.

8. The waste disposal service panel assembly of claim 1, wherein said service panel door further includes a handle configured to lock in the closed position, and when properly stowed and locked, a distal portion of said handle is positioned at a 7 to 8 o'clock position relative to the aft portion of the aircraft being at 9 o'clock.

9. The waste disposal service panel assembly of claim 8, where when said handle is open, said service panel door opens under its own weight and both said handle and said service panel door hang open at a 7 to 8 o'clock position relative to the aft portion of the aircraft being at 9 o'clock.

10. A waste disposal service panel assembly of claim 1, wherein at least two components are manufactured as a single unit, said components selected from a group consisting of: said housing, said waste drain valve, a housing of said waste drain valve, and a rinse/fill valve housing.

11. A waste disposal service panel assembly of claim 1, wherein said outer cap is incorporated into said service panel door.

12. A waste disposal service panel assembly of claim 1, wherein said outer cap is coupled to said underside of said service panel door.

13. A waste disposal service panel assembly comprising:
a housing comprising a substantially tubular side wall and a base near one end of said side wall;
a waste drain valve at least partially mounted within said housing through said base, where said waste drain valve includes an outlet positioned within said housing and an inlet configured to couple to a waste collection tank;
a service panel door pivotally coupled to said housing near an end of said side wall remote from said base, where said service panel door comprises:
an outer surface configured to substantially match an outer contour of an aircraft's skin; and
an outer cap coupled to an inner surface of said service panel door, said outer cap configured and dimensioned to mate with said outlet to seal said outlet when said service panel door is closed.

14. The waste disposal service panel assembly of claim 13, wherein said housing further includes a rinse/fill valve and handle assembly coupled to said housing.

15. The waste disposal service panel assembly of claim 13, wherein said housing, is configured and dimensioned such that said service panel door cannot close if at least one waste drain valve component within said housing is not in a closed position.

16. The waste disposal service panel assembly of claim 13, wherein said waste drain valve further comprises an inner door pivotally mounted within said outlet.

17. The waste disposal service panel assembly of claim 13, wherein said service panel door further includes a handle configured to lock in the closed position, and when properly stowed and locked, a distal portion of said handle is positioned at a 7 to 8 o'clock position relative to the aft portion of the aircraft being at 9 o'clock.

18. The waste disposal service panel assembly of claim 17, where when said handle is open, said service panel door opens under its own weight and both said handle and said service panel door hang open at a 7 to 8 o'clock position relative to the aft portion of the aircraft being at 9 o'clock.

19. A waste disposal service panel assembly of claim 13, wherein at least two components are manufactured as a single unit, said components selected from a group consisting of: said housing, said waste drain valve, a housing of said waste drain valve, and a rinse/fill valve housing.

20. A waste disposal service panel assembly of claim 13, wherein said outer cap is incorporated into, or coupled to, said underside of said service panel door.
